(19) United States
(12) Patent Application Publication
(10) Pub. No.: US 2010/0304343 A1
(43) Pub. Date: Dec. 2, 2010

(54) Method and Apparatus for Language Instruction

(76) Inventor: Louis R. Bucalo, Lauderdale By the Sea, FL (US)

Correspondence Address: BOYLE FREDRICKSON S.C., 840 North Plankinton Avenue, MILWAUKEE, WI, 53203, US

(21) Appl. No.: 12/792,143

(22) Filed: Jun. 2, 2010

Related U.S. Application Data
(60) Provisional application No. 61/183,294, filed on Jun. 2, 2009.

(51) Int. Cl. G09B 19/06; G09B 19/04

(52) U.S. Cl. 434/157; 434/185

(57) ABSTRACT

A system is provided for acquiring increased proficiency in a new or target language by enabling frequent repeated hearing and mimicking of discrete audio sound bites in the target language, wherein the sound bites and their frequency of repetition may be easily selected by the user before or during use. The sound bites may be played singly or in sequential groups or user defined groups, and automatically repeated as necessary or desired to achieve audio imprinting of the sound bites by simply listening and repeating the sounds without substantial intellectual effort or attempts at memorization. The system enables user selected or sequential hearing and mimicking of specific sound bites or groups of sound bites repeatedly in each use session in the context of meaning, without requiring dedicated language learning time, and thereby helps reproduce the natural process of initial native language acquisition which occurs without substantial intellectual effort and memorization.

### CROSS-REFERENCE TO RELATED APPLICATIONS

This application claims priority to U.S. provisional application Ser. No. 61/183,294, filed Jun. 2, 2009, the entire contents of which are incorporated herein by reference.

### BACKGROUND OF THE INVENTION

At very young ages, people acquire verbal communication skills and learn spoken languages easily and naturally, without any direct intellectual effort. Children learn spoken languages by simply hearing very frequent repetition of words, phrases, and sentences that are spoken by others. This process of audio imprinting occurs without any direct analytical effort or intellectual learning and memorization. The key to this process is the very frequent repetition of sounds that occur in the context of the same repeated actions, situations or events which provide meaning, which are then naturally subconsciously associated with the sounds (words, phrases, and sentences). In this way, both the sounds (words, phrases and sentences) and their meaning are naturally acquired without trying to remember, memorize or analyze anything. The sounds are imprinted through very frequent repetition, and are thereby internalized, similar to musical tunes which are effortlessly remembered after frequent repetition. Humans can very easily accurately mimic a short group of sounds that they hear, if there is no simultaneous conscious attempt to analyze or decipher the sounds. The accurate mimicking of the sounds is easily done if there is no other conscious process interfering, such as the attempt to analyze the sounds for meaning, or see the spelling of the words in their mind, etc. This is the way children naturally learn to mimic sounds and acquire spoken language. The sound and pronunciation of each word, phrase, or sentence is not acquired through effort or memorization. It is acquired through very frequent exposure to repetition of sounds as sounds, without any purposeful analytical effort to decipher meanings, spellings or other simultaneous conscious intellectual processes. The meaning of the sounds is acquired subconsciously through the repeated exposure of the sounds and groups of sounds in the same context. The human brain naturally associates the sounds with the context, and naturally subconsciously figures out the meaning of individual words and sentences. Children do not try to remember or memorize anything, yet they very effectively acquire spoken language with very little intellectual capability. For example, at age 3, children generally have a speaking vocabulary of approximately 900 words. At age 4, children generally have a speaking vocabulary of about 1500 words and can easily communicate verbally with adults. They have also naturally acquired the basics of grammar and other mechanics of spoken language to effortlessly communicate basic ideas and everyday conversations. This process of verbal language acquisition is something that everyone is able to do relatively effortlessly, not only as a child to acquire their first language, but also as an adult to acquire a second language. The problem has been that there has been no device or method which can be utilized within the context of an adult individual's daily routine to effectively enable this natural language learning process for acquiring additional languages as an adult.

Many adults and school-aged children currently learn a new language using methods that require substantial amounts of direct effort at memorization and other intellectual effort. In other words, programs for teaching people new languages do not present learning materials in a way that recreates the natural way that children learn to speak, through repeatedly providing audio words, phrases, and sentences in a context providing meaning, and then simply hearing and repeating them very often without trying to understand, analyze or memorize them at all.

Some programs for teaching new languages are implemented in classroom or school settings, often teaching students both the spoken and written new languages at the same time. This approach is highly academic, typically follows a pre-established content, and requires substantial intellectual efforts. In these classroom settings, students often will deliberately try to visualize, for example, word-for-word translation of content, trying to memorize content and then consciously recall the information from memory. In addition to trying to translate content in this way, users of these programs also try to consciously resolve any grammatical or other structural-type differences between the native and target language versions. This is a complex way of learning which requires dedicated classroom and/or other time from the users of these programs. In addition, successfully using such programs can be difficult for busy people or people that are otherwise unable to attend the sessions regularly.

In addition, the process of trying to analyze what is being spoken actually interferes with the natural human capability to easily mimic sound bites accurately. In other words, when students try to “see” what they are saying in their mind and analyze meaning, grammar etc., their mind is distracted from the task of simply repeating the sounds they heard. However, if the person just speaks the words over and over, the process of audio imprinting and muscle memory naturally takes over, and the sounds become a natural part of the person's library of sounds that they can reproduce effortlessly. If the general meaning or context is provided at the same time, the meaning of the words is acquired naturally, subconsciously over time without any intellectual effort. Current devices and methods for acquiring new languages do not enable this approach.

Other current programs and systems have been provided that are “self-taught” alternatives to the classroom programs and which are commonly referred to as “personal language programs.” Typical personal language programs currently available are audio programs or have audio containing formats for learning new languages. Personal language programs include computer-based programs, internet-based programs, CDs, and tapes that contain audio content, all of which provide information for learning, and audio content for reference and practice.

Some known computer-based personal language programs are modeled, at least to some extent, to the classroom programs, but allow users to study within their own residences. Various “language lab”—type programs have been provided as computer-implemented software that allows users to study content through their own computers and record their own pronunciations for later analysis. Similar to classroom programs, users of these systems try to memorize what they are hearing and have to devote dedicated blocks of time per session, for example, an hour or two at a time, while interacting with their computers. Many adults do not have the opportunity in their daily routine to devote such large amounts of dedicated time to acquire a new language. These programs are often complex and have contents that are pre-established by the writers of the software and are reflected in how the software lays out the program, the predetermined progress of the program, and how the users interact with the software to implement the program. These systems require substantial amounts of user interaction with the users' computers during time that is devoted to the dedicated language learning sessions, whereby successfully using such programs can be difficult for busy people or people that are otherwise unable or unwilling to dedicate time to computer or book based learning.

Other known computer-based personal language programs, having relatively less in common with classroom program contents, have been gaining popularity recently. Examples of these include the Rosetta Stone programs and other such programs. The Rosetta Stone program content presents, for example, computer-based visual and audio representations of virtual immersive environments, such that users see visual images or video scenes that are displayed through their computer screens in addition to audio content. Such programs are complex and have contents that are pre-established by the writers of the software and are reflected in how the software presents the video scenes of the virtual immersive environments and other content. These systems require substantial amounts of user interaction with and input into the users' computers during large blocks of time that are devoted to the dedicated language learning sessions, whereby successfully using such programs can be difficult for busy people or people that are otherwise unable to devote time to dedicated language learning sessions. Many people buy such programs, try them a few times, and then stop using them because they cannot afford the time required or do not feel like sitting in front of their computers for an hour or two each day in order to learn a new language. In addition, importantly, the device, content and method of use do not enable the natural process of acquiring a spoken language by allowing the user to repeatedly hear and repeat sound bites as desired many, many times in a row in each session of use, for the natural process of audio imprinting to occur. They are based instead upon an intellectual process of memorization with only a few repetitions of such sound bites per session, and integrate writing and reading which impair the natural audio imprinting process.

Other personal language programs are audio based, so that a computer is not required for presentation of the content of these programs, but are instead delivered through CDs, tapes, and/or other audio storage media such as, for example, in MP3 format that is playable on iPods or other MP3 players. For the sake of convenience and in the interest of brevity, CDs, tapes, MP3 format, and/or other audio storage media are simply referred to as “CDs” hereinafter. Popular examples of audio-based personal language programs are the Pimsleur and Berlitz programs which are delivered through CDs. The Pimsleur programs deliver material by, for example, presenting conversations, dialogues, or other content within travel or other fictional audio scenes and which are occasionally reintroduced in smaller segments, periodically throughout the programs as determined by the pre-established content by the authors of the CD content. The organization and presentation of the audio content in such programs makes it very difficult for users to repeat specific sound bites of the content many times in a row for audio imprinting to be enabled. The CD content is arranged and divided so that, in order to repeat content, users must stop the CD or tape or audio file, rewind, find the same spot at the beginning of the desired phrase or sentence, and replay it. This is too much of an inconvenience and most users do not bother doing all of these steps in order to repeatedly hear and mimic specific sound bite(s) many times, which greatly decreases the usefulness of the learning session. Instead, users tend to let several phrases or sentences go by, not understanding them or bothering to try to repeatedly practice them. This decreases the effectiveness of the instructional materials, leading to less effective learning. With such current devices and methods, it is virtually impossible for someone to utilize the natural audio imprinting process efficiently and effectively, and hear and repeat user selected sound bites many times, for example, 25-100 times, throughout the day,

Prior art programs for teaching people new languages tend to require large blocks of time that are dedicated to the language learning session, in front of a computer or by physically attending classes, reducing the practicality of these systems for many busy people or people that are otherwise not interested in spending substantial amounts of time in front of computers or attending classes.

Prior art language programs that are audio based and utilize CD's, tapes and MP3 files allow someone to use the program in their car CD player, carry an iPod or some other less dedicated language learning session, but the presentation, organization and functionality of such devices and methods do not enable the audio imprinting process effectively because the user is not exposed to small groups of sound bites that are repeated many, many times, and the sound bites cannot be easily user selected and organized and repeatedly heard and mimicked many times, say 25-100 times per day or more, in order for the audio imprinting process to occur efficiently without any need for intellectual effort and memorization.

Prior art programs for teaching people new languages tend to present material in ways that require memorization or other substantial intellectual efforts, which can prove frustrating for users and fails to take advantage of how people naturally learn a first spoken language.

Prior art programs for teaching people new languages tend to follow pre-established contents and/or provide content organization and division that frustrates efforts to customize these programs while trying to address particular learning needs or desires of individual users.

Prior art programs for teaching people new languages provide content that is not arranged, divided, or organized in a manner that allows for easily repeated playing of a specific word, phrase, or sentence as desired by a particular user, whereby repeating requires cumbersome stop, rewind, hunt, and find processes which are prohibitively laborious and obstacles to learning.

Known portable audio playing devices such as iPods, MP3 players, and/or others, have been provided only with the prior art programs for teaching people new languages and therefore also provide content that is not arranged, divided, or organized in a manner that allows for easily repeated playing of a specific sound bites, that is, words, phrases, or sentences, as desired by a particular user, whereby repeatedly hearing specific content requires cumbersome stop, rewind, hunt, and find processes to control content delivery on an as-desired basis by the user, which are prohibitively laborious and obstacles to learning.

### SUMMARY OF THE INVENTION

In light of the foregoing, a system for learning a new or target language is desired that improves the state of the art by overcoming one or more of the aforesaid problems of the prior art.

In accordance with an aspect of the invention, at least one of these desires is fulfilled by providing a system for learning a target language by the particular configuration of one or more of (i) the functionality of a device that is implemented to deliver content; (ii) the particular content itself, and (iii) the organization of the content, with the system being configured to enable very frequent repetition and exposure to specific sound bites in a normal daily routine, while providing progressive content and frequent daily opportunity for practice and exposure thereto, as desired by the user.

In accordance with another aspect of the invention, the system provides for frequent exposure to and repeated mimicking of specific sound bites in the target language within the user's normal daily routine, or while performing routine daily activities, such as making meals, getting dressed, doing housework, driving to work, exercising, etc., while providing progressive content and frequent daily opportunity for practice and exposure thereto, as desired by the user. The invention enables specific sound bites, that may be user selected and organized, to easily be heard and mimicked repeatedly many times throughout the day, in order for the natural process of audio imprinting to occur.

In accordance with another aspect of the invention, the system provides for integration of the target language exposure and practice into users' normal daily routines, allowing the user to acquire a new spoken language without having to dedicate substantial amounts of time to such language acquisition.

In accordance with another aspect of the invention, the system does not require daily dedicated time in front of a computer, stereo, or book, and minimizes reliance on memorization as a learning component.

In accordance with another aspect of the invention, the system exposes the user to the target language in a manner that closely corresponds to the way in which people naturally learn a first or native spoken language, by audibly presenting discrete sound bites that can include words, and/or phrases, and/or sentences, in very high repetitions in the target language while providing at least a general context of corresponding meaning or definition to help provide understanding, and allowing the user to mimic corresponding sounds. This general context may be provided by an audio file in the person's native language, or a video file, or any combination of audio, visual media.

In accordance with another aspect of the invention, the system provides content by way of sounds and groups of sounds that are repeated often through the day so as to duplicate a natural process of hearing and repeating sounds spoken by others, or like repeating a short musical phrase that is heard many times, instead of requiring intellectual efforts.

In accordance with another aspect of the invention, the system provides discrete sound bites that are words, phrases, or sentences, that are easily individually identified and replayed for many repetitions at a given time or throughout an entire day, in a manner that facilitates natural, relatively more effortless language acquisition.

In accordance with another aspect of the invention, the system provides ways of easily repeating specific segments of audio content, allowing repeated hearing and repeating of such specific segments of audio content according to the individual user's needs.

In accordance with another aspect of the invention, the system provides sound bites that include words, phrases, or sentences that are easily and immediately repeated over and over as desired by each given user, until the user feels comfortable that he or she has mastered the particular sound bite(s), and decides to advance to another sound bite or sound bites. The system correspondingly provides discreet sound bites that can be mastered individually or in small groups, and easily individually replayed and repeated as desired by a given user, without requiring the user to rewind and hunt for a particular word, phrase or sentence in a dialogue, conversation, or other presentation that the user did not quite understand, or when the user wants to practice repeating more times right at that moment.

In accordance with another aspect of the invention, the system includes a portable or other electronic device that is configured to store audio-based content thereon or access audio-based content therethrough for teaching a user of the system a new or target language. The audio-based content includes multiple sound bites and each of the sound bites may have (i) a native language audio segment defined by at least one of a word, phrase, or sentence that is audibly rendered or played in a native language to the user; and (ii) a target language audio segment that is an audible rendering or playable representation of the native language audio segment in the target language being learned by the user. The sound bite may further include a silent audio segment that is provided after the target language audio segment and has a duration that is sufficiently long to allow a user to mimic and repeat the target language segment one or more times. Such silent audio segment may be provided as part of each of the sound bites, as a discrete audio file that is between sound bites, or otherwise stored on or accessible through the device.

In accordance with another aspect of the invention, the sound bites are relatively short audio events, and may be discrete audio files. Each of the sound bites may have a total duration of not more than about 15 seconds. Or, at least one of the components of the sound bites can have a duration of not more than about 15 seconds, whereby at least one of the native language audio segment, target language audio segment, and optional silent audio segment, may have a duration not more than about 15 seconds.

In accordance with another aspect of the invention, the system includes a user interface that interacts with the portable device and has a selector that is configured to individually select one of the sound bites, or a preset group of sequential sound bites, or a user-defined group of sound bites so as to provide a user-defined during use. The user-defined session content can be easily dynamically changed or dynamically redefined, so as to accommodate changes in the user's preferences or objectives at any given time.

In accordance with another aspect of the invention, the sound bite or group of sound bites may be repeated during the learning session. A repeat mode selector may be provided that allows the user to determine how many times the sound bite or group of sound bites will be repeated. The repeat mode selector may also be used before the use session begins so as to predetermine how many times a sound bite or group of sound bites will be repeated during use. The repeat mode selector may be used or changed during the practice session to dynamically redefine how many times a sound bite or group of sound bites will be repeated during the remainder of use at a particular time. An individual repeat selector may be provided that allows the user to instantaneously repeat a sound bite or group of sound bites that is currently being audibly rendered or has previously been audibly rendered, one or more times. A repeat-once setting may be provided that, when used, repeats the chosen sound bite or group of sound bites a single time. A repeat-five-times setting may be provided that, when used, the sound bite or group of sound bites selected is automatically repeated five times in a row. A repeat-continuously setting may be provided that, when used, the sound bite or group of sound bites is repeated continuously until the user commands the device to cease audibly rendering the sound bite or group of sound bites of the user-defined session content.

In accordance with another aspect of the invention, the device may include a button or switch that when activated automatically advances the device to a new or sequential group of preselected or user defined sound bites, allowing the user to easily advance to new content, as, for example, after the user has heard and repeated a given sound bite or group or sound bites many times, and would like to advance to a new sound bite or group of sound bites. This process may be repeated by the user.

In accordance with another aspect of the invention, the sound bites are discrete audio files that are individually tagged, queued, or otherwise associated with a unique identifier, so to allow their individual selection for being played, placed into one or more user-defined or other groups, and repeated. Optionally, the sound bites function as though they were discrete and individually tagged audio files, but are instead components of a single audio file that are tagged, queued, or otherwise associated with a unique identifier so as to be individually selectable segments of the single file.

In accordance with another aspect of the invention, the system provides more than one play mode that establishes more than one play characteristic of the sound bite or group of sound bites. The more than one play mode can be implemented by way of more than one play button, each of which is assigned a corresponding play mode that differs from the others.

In accordance with another aspect of the invention, the system provides at least about 100 sound bites that are stored thereon or accessible therethrough. The system may include at least about 1000 sound bites that are stored thereon or accessible therethrough.

Various other features, embodiments and alternatives of the present invention will be made apparent from the following detailed description taken together with the drawings. It should be understood, however, that the detailed description and specific examples, while indicating preferred embodiments of the invention, are given by way of illustration and not limitation. Many changes and modifications could be made within the scope of the present invention without departing from the spirit thereof, and the invention includes all such modifications.

### BRIEF DESCRIPTION OF THE DRAWING(S)

Preferred exemplary embodiments of the subject matter disclosed herein are illustrated in the accompanying drawings in which like reference numerals represent like parts throughout, and in which:

FIG. 1 is a schematic view of a system for learning a new or target language in accordance with the present invention;

FIG. 2 is a schematic view of an electronic device of the system shown in FIG. 1;

FIG. 3 is a front elevation view of a variant of the electronic device shown in FIG. 2;

FIG. 4 is a schematic view of a portion of the audio content, taken generally along the dashed oval labeled “FIG. 4” in FIG. 1;

FIG. 5 is a schematic view of a sound bite of the audio content shown in FIG. 1;

In describing the preferred embodiments of the invention which are illustrated in the drawings, specific terminology will be resorted to for the sake of clarity. However, it is not intended that the invention be limited to the specific terms so selected and it is understood that each specific term includes all technical equivalents which operate in a similar manner to accomplish a similar purpose. For example, the word “connected”, “attached”, or terms similar thereto are often used. They are not limited to direct connection but include connection through other elements where such connection is recognized as being equivalent by those skilled in the art.

### DETAILED DESCRIPTION OF THE PREFERRED EMBODIMENT

As discussed in the “Summary” section above, the invention relates to a system for learning a foreign, new, or other target language. Various embodiments of a system for learning a target language will now be described that achieve at least some of these and many other goals, it being understood that other configurations may be provided that fall within the scope of the present invention. Such exemplary embodiments of the system of the present invention are illustrated in the accompanying drawings in which like reference numerals represent like parts throughout.

1. System Overview

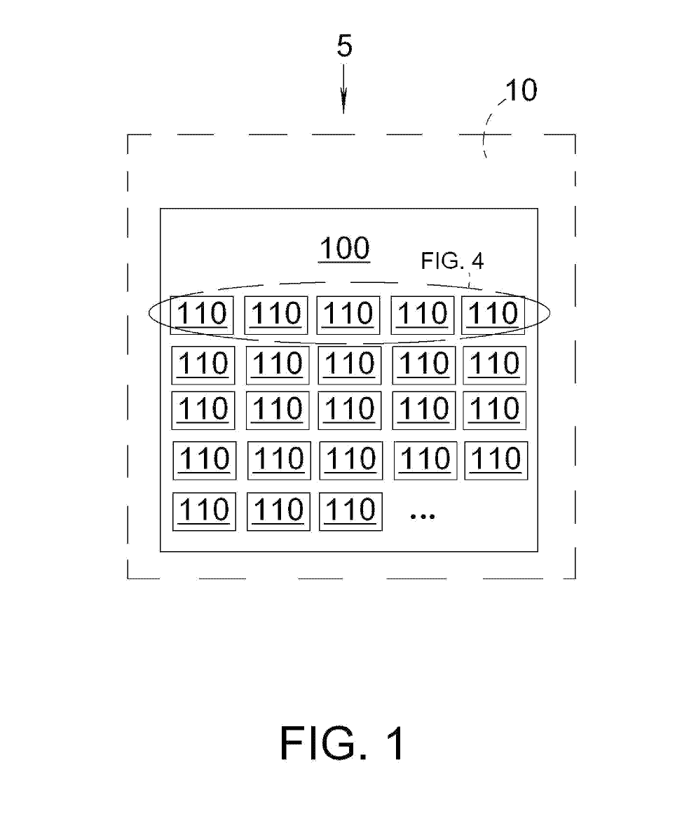

FIG. 1 schematically shows a system 5 for learning a new or target language. The system includes an electronic device 10 that has audio content 100 stored on it or accessible through it. For the sake of convenience and in the interest of brevity, audio content 100 that is stored on the device 10, as well as audio content 100 that is accessible through the device 10, are simply referred to as being “stored” herein, whereby the audio content 100 may instead be accessible through the internet, stored on removable memory or memory that is not directly provided within the device, or memory within a computer that is separate from but in communication with the device 10, base on the particular desired end-use configuration of the system 5. The audio content 100 is organized in a way that facilitates easy selection of small or discrete portions thereof, as well as allowing for easy user manipulation and/or repeated playing thereof by the user, through the device, as explained in greater detail elsewhere herein.

The system 5 provides for frequent repetition and exposure as needed or desired to sound bites in the target language in a manner that allows a user to acquire or learn the new language during learning sessions that can be fully integrated into users' normal daily routines. In this way, the system 5 presents the practice session so that it is implemented as a secondary or background activity, when compared to tasks (primary activities) being performed within the daily routine of the user. The system 5 accomplishes this by presenting material in a way that closely resembles the way in which people naturally learn a first or native spoken language, through very frequent presentation of sounds within a context of meaning, and by enabling frequent repeated mimicking of those sound bites so as to imprint the same within the memory of the user without requiring substantial, conscious, intellectual efforts.

The preferred system 5 presents material from the audio content 100 as discrete sound bites 110 that are complete words, and/or phrases, and/or sentences that can be easily played, selected, repeated, grouped together for playing, repeating, or sequentially progressing through, while allowing a user to dynamically reconfigure the content being played and its delivery as desired, whereby content of a use session can be user-defined and dynamically redefined, as desired.

2. Electronic Device

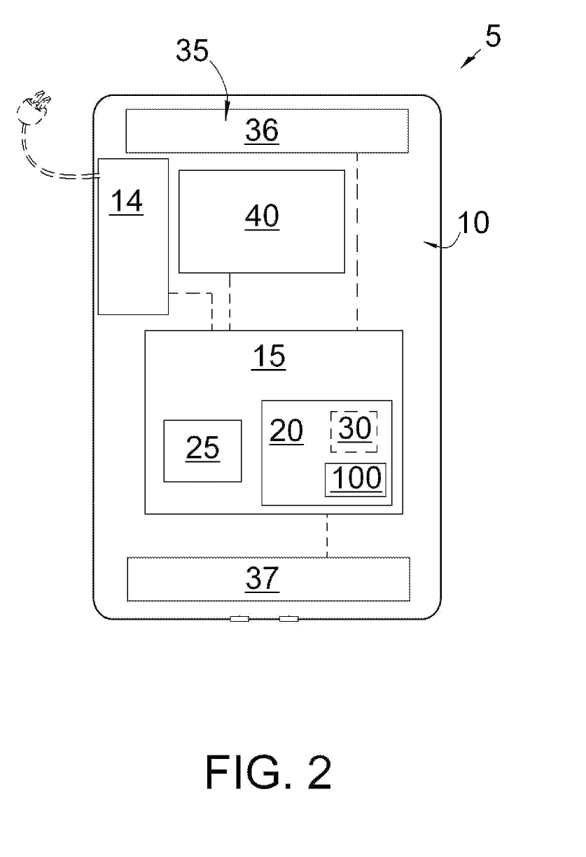

Referring now to FIG. 2, electronic device 10 of system 5 has various components that are operably connected to each other by way of electrical and/or data conductors or connectors in a known manner. The device 10 includes a power supply 14 that can be a battery, rechargeable or disposable, or can include a cord that conveys power from, for example, an AC outlet or a USB or other port of a computer. The power supply 14 provides power to a processing block 15 which includes suitable memory 20, processor(s) 25, and software 30 for performing the system logic.

Still referring to FIG. 2, processing block 15 communicates with a display system 35 that includes, for example, a visual display device 36 that can be any one of a variety of suitable visual display devices, including liquid crystal displays (LCDs), organic light-emitting diode (OLED) displays, fast super-twisted nematic (FSTN) displays or super-twisted nematic displays (STN), and/or others. An audio display device 37 is provided within the display system 35 that is configured to convey audio information to the user, for audio rendering or playing the audio content 100. Audio display device 37 includes, for example, speakers, headphone jack, or other device can audibly render or conveys information to users, making the sounds that the user hears when the processing block 15 plays the sound bite or bites 110 of the audio content 100.

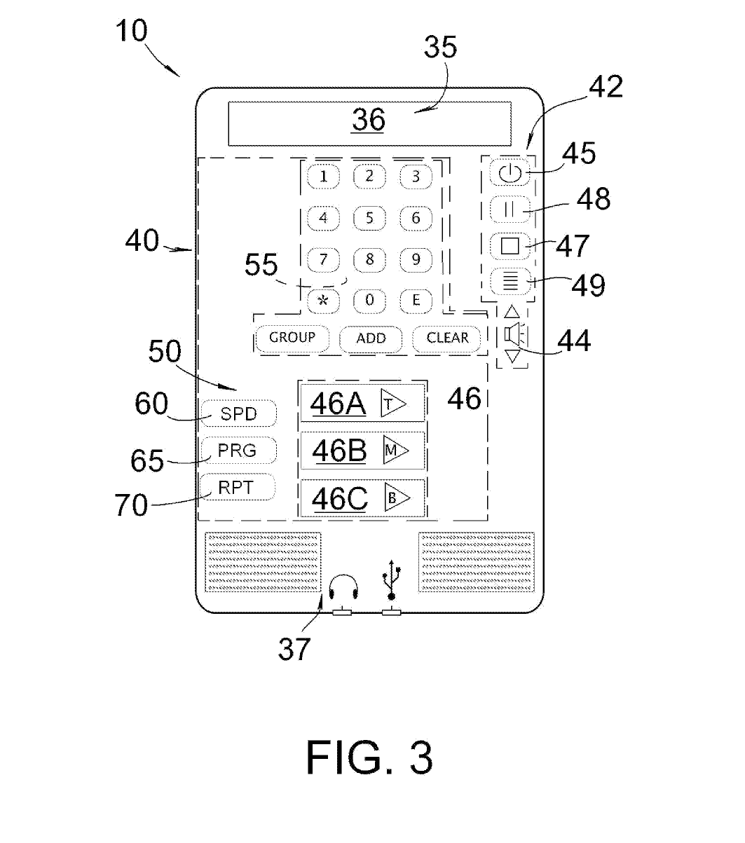

Still referring to FIG. 2, processing block 15 also communicates with and receives instructions from a user interface system 40 that is configured to allow users to control operations of the device 10. The user interface system 40 includes general controls 42 (shown in FIG. 3) for controlling general operations and functions of the device 10.

Referring now to FIG. 3, the general controls 42 in this non-limiting embodiment include volume buttons 44, a power button 45, a play button 46, a stop button 47, a pause button 48, and a list button 49. The general controls 42 perform corresponding functions, with the volume buttons 44 controlling the volume at which the speakers, headphone jack, or other component of the audio display device 37 emits or transmits an audio rendering of the audio content 100. The power button 45 turns the device 10 on or off, and the play, stop, and pause buttons 46, 47, 48 start, stop and pause delivery of the audio content 100, respectively. The embodiment of FIG. 3 includes three play buttons, 46A, 46B, and 46C that allow for quick activation of three different content delivery modes that can be used in a staged progression of how the audio content 100 is presented to the user. For example, the three play buttons 46A, 46B, and 46C can activate different repeat modes and/or other modes of the device 10 as described in greater detail elsewhere herein.

The list button 49 is used to display an index or other list-like representation that displays on the visual display device 36, for example by listing the sound bites 110 that are stored on the device 10 or are within a particular user-defined or other group of sound bites 110.

The general controls 42 in some embodiments further include the other controls that are typically found on portable audio devices, such as MP3 and/or other portable audio players, including but not limited to a shuffle or random button, skip ahead or behind buttons, and/or others which are operably connected to the processing block 15 which may be usable for controlling various functions of the device 10 during learning session but also to allow the device 10 play songs or other popular culture audio files when the device 10 is not being used for language learning.

Referring yet further to FIG. 3, the user interface system 40 includes a selecting system 50 that is configured for allowing the user to control, define, and redefine various play modes and/or other operating parameters of the device 10. Selecting system 50 includes a sound bite selector 55, a speed mode selector 60, a progression mode selector 65, and a repeat mode selector 70. The sound bite selector 55, speed mode selector 60, progression mode selector 65, and repeat mode selector 70 in this embodiment are illustrated schematically as distinct keys, buttons, or switches. However, in some embodiments, the sound bite selector 55, speed mode selector 60, progression mode selector 65, and repeat mode selector 70 all part of a single keypad or are different options that are accessible as navigable menus that are displayed on the visual display device 36 and are manipulated by a common set of keys, buttons, or switches.

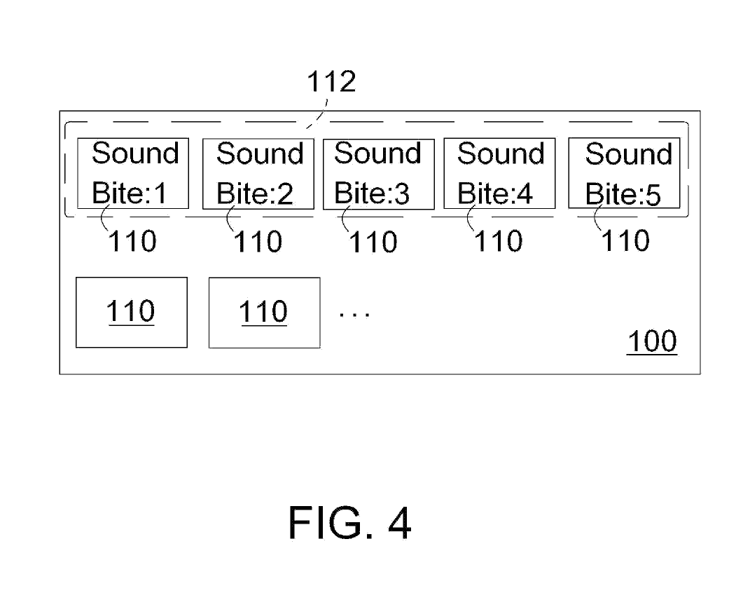

Referring still to FIG. 3, in this embodiment, the sound bite selector 55 includes a keypad having numbered keys or buttons that allow the user to enter one or more numbers into the device. In some embodiments, the sound bites 110 are sequentially numbered and the user picks one or more of the sound bites 110 to play by entering the number or numbers that correspond to the sound bite or bites 110 through the sound bite selector 55. Stated another way, sound bite selector 55 allows the user to at least partially define content for a particular use session by selecting, for example, which sound bite or sound bites 110 to play, which sound bite 110 to begin sequentially playing from, and/or which sound bites 110 will be in a user-defined group 112 (shown in FIG. 4) for playing, which is explained in greater detail elsewhere herein. In this embodiment, the sound bite selector 55 includes individual keys or buttons, with exemplary labels of “GROUP”, “ADD”, and “CLEAR” that cooperate with processing block 15 and other numbered keypad of the sound bite selector 55 to facilitate formation and modification of the user-defined group 112 (shown in FIG. 4).

Still referring to FIG. 3, speed mode selector 60, progression mode selector 65, and repeat mode selector 70 of this embodiment are all separate buttons that are electrically connected to and interact with the processing block 15 (shown in FIG. 2). The speed mode selector 60 controls whether a slow or natural speed version of a sound bite 110 or part thereof is played. The progression mode selector 65 controls whether and to what extent the audio content 100 is automatically progressed through during a study session. The repeat mode selector 70 controls whether and to what extent portions of the audio content 100 are repeated during a study session. The repeat mode selector 70 can include the three play buttons 46A, 46B, and 46C

Referring now to FIGS. 2 and 3, preferably, the device 10 is configured as a relatively small and highly portable handheld device. All of the power supply 14, processing block 15 and its cooperating components, display system 30, and user interface system 40 of this embodiment are held within a housing 11. In at least one embodiment, the housing 11 is about 2-4 inches wide, about 3-6 inches in height, and about ½-1 inch thick, with the height and width dimensions are interchangeable and while noting that other dimensions or ranges of dimensions can be used, depending on the intended end-use configuration of the device 10. A mounting system 12 is attached to housing 11 and is configured to allow the device 10 to be removably mounted to a variety of surfaces. For example, in this embodiment, the mounting system 12 includes a reversible suction cup, that allows reversible attachment of the device 10 to a wall surface, appliance surface such as a refrigerator, or car dashboard. The mounting system 12 is preferably detachable from the housing 11 so as to allow easy placement of the device 10 in a pocket, on a table, or for more comfortably holding the device 10 in the user's hand, as when jogging or walking.

In yet other embodiments, the device 10 is not handheld but is, instead, incorporated into a personal computer such as a stand-alone personal computer or a more portable laptop computer. In these embodiments, the look of the device 10 or portions thereof may be graphically replicated for display on the graphical user interface of the computer. In these embodiments, the power supply 14, processing block 15 and its cooperating components, display system 30, of the device 10 are provided by the power supply, processing system, and monitor of the computer. The selecting system 50 is then implemented through appropriate software so as to allow the computer to include sound bite selector 55, speed mode selector 60, progression mode selector 65, and repeat mode selector 70, and to store the audio content 100 thereon, for implementation as language learning system 5.

3. Audio Content

Referring now to FIGS. 1 and 4, the audio content 100 includes multiple discrete sound bites 110 that convey a complete word, phrase, or sentence. The sound bites 110 are electronic audio files that are stored on the memory 20 (shown in FIG. 2) of or elsewhere on the device 10 so as to be in a readily retrievable and playable format. The sound bites 110 can be preloaded onto the device 10 by the manufacture/distributor. Additional sound bites 110 and/or other audio content 100, similarly or otherwise arranged, may be added to the device 10 through downloading such content from a website via the internet or other audio data transfer methods, as may be made available by the manufacturer/distributer of the device 10 for sale or distribution to device 10 owners and users. This allows the audio content 100 to be supplemented, modified, fully replaced, and/or otherwise manipulated either by the user of the device 10 or as permitted by the manufacturer/distributer of the device 10.

Still referring to FIGS. 1 and 4, the number of sound bites 110 that are stored on the device 10 at any given time is preferably large, whereby the device 10 can store at least about 100, at least about 500, at least about 1000, or more, on its memory 20 or elsewhere. The particular number of sound bites 110 that is stored on the device 10 is a function of both the storage size of the memory 20 and the particular file size of each of the sound bites that will be at least partially influenced by which type of audio file is used for making the sound bites 110. The sound bites 110 can be any of a variety of suitable electronic audio files, including, but not limited to, MPEG-1 Audio Layer 3 (MP3), Windows Media Audio (WMA), Waveform Audio (WAV), Music Instrument Digital Interface (MIDI), Advanced Audio Coding (AAC), Adaptive Differential Pulse Code Modulation (ADPCM), Advanced Streaming Format (ASF), Vector Quantization Format (VQF), and/or others.

Referring now to FIGS. 1-4, each sound bite 110 is electronically tagged, queued, or otherwise associated with a unique identifier to easily label each of the sound bites 110. The sound bites 110 of this embodiment are sequentially numbered, allowing the user select and, for example, play or group together one or more particular sound bites 110, such as, Sound Bite:1, Sound Bite:2, or Sound Bite:3, into a group 112 (shown in FIG. 4) by entering the desired number associated with that sound bite 110 using the keypad buttons of the sound bite selector 55 (shown in FIG. 3) of the user interface system 40, which is explained in greater detail elsewhere herein.

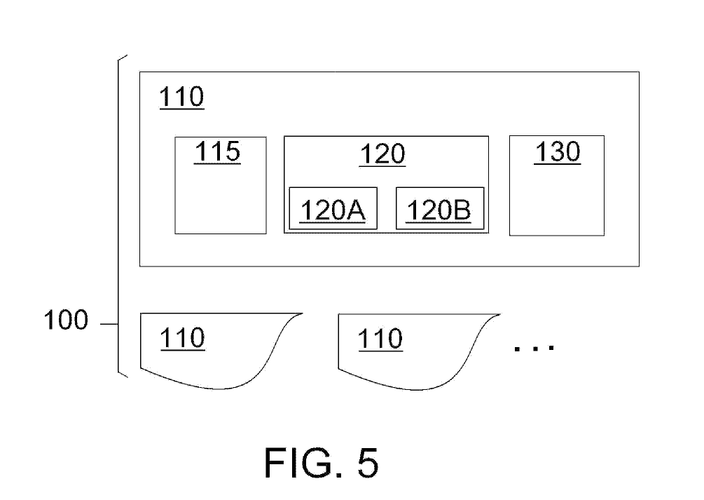

Referring now to FIG. 5, each sound bite 110 includes a native language audio segment 115 and a target language audio segment 120. The native language audio segment 115 conveys the word, phrase, or sentence, in a native or known language to the user, so that it is understood by the user and provides context form the associated target language audio segment 120. The target language audio segment 120 of this embodiment includes two versions, a slow speed version 120A and a natural speed version 120B. The slow speed version 120A provides a relatively slower pronunciation for improved comprehension by the user, while the natural speed version 120B provides a relatively quicker or more realistic pace of pronunciation for realism and additional practice. Preferably, the natural speed version 120B is, itself, individually tagged, queued, or uniquely identified within the sound bite 110 so as to allow the user to either play the natural speed version 120B or not play and therefore skip over the natural speed version 120B, by using the speed mode selector 60 to include or exclude the natural speed version 120B while playing the sound bite 110. Even more preferably, each of the segment of the sound bite 110, that is the (i) native language audio segment 115, (ii) target language audio segment slow speed version 120A, and (iii) the target language audio segment natural speed version 120B is, individually tagged, queued, or uniquely identified within the sound bite 110 so as to allow the user to either play the not play the particular segment, as desired and depending on the particular play mode of the device 10.

Still referring to FIG. 5, in this embodiment, the sound bite 110 further includes a silent audio segment 130, which is preferably arranged after the target language audio segment 120. Silent audio segment 130 has a duration that is sufficiently long to allow a user to practice pronouncing the target language segment one or more times. In another embodiment, the silent audio segment 130 is provided as its own file which is separate from the sound bite 110, but can be arranged for play directly after the sound bite 110 to again provide adequate time for pronunciation practice.

Referring now to FIGS. 1, 4, and 5, preferably, each sound bite 110 has a total duration of not more than about 15 seconds. In some embodiments, each sound bite 110 has a total duration of less than about 18 or 20 seconds, but in any event, preferably being no longer than about 30 second. In yet another embodiment, one or more of the components of the sound bite 110 such as the native or target language audio segments 115, 120 and/or the silent audio segment 130 has a duration that is less than about 15 while the entire sound bite 110, itself, may have a somewhat longer duration.

4. System Use

Referring now to FIGS. 1-3, system 5 is preferably used in the following way. Initially, the user presses the list button 49, or otherwise evaluates the overall collection of sound bites 110 within the audio content 100. If the user wants to change the audio content 100 in any way, for example, by completely changing the content to provide study of a different target language, to switch the particular sound bites 110 in the same target language that will be saved on the device 10, or to supplement or add to the collection of sound bites 110 that are saved on the device 10, the use can do so before starting a learning session. Accordingly, before beginning a learning session, the user may download from a website or from a computer, or otherwise transfer audio content 100 to the device 10. When the user is satisfied with the particular audio content 100 on the device 10, the user at least partially defines a session content by manipulating the selecting system 50 or by delivering the audio content 100 in a particular way by pressing three play buttons 46A, 46B, and 46C without using the selecting system 50.

Referring now to FIGS. 3 and 4, for embodiments of device 10 that include three play buttons 46A, 46B, and 46C, the user can initially define the session content by selecting which three play buttons 46A, 46B, and 46C to press and, correspondingly, which of the corresponding delivery modes to implement. In one embodiment, pressing the top play button 46A, begins a learning session of a group 112 of the first five sound bites 110 and plays the group 112 of the first five sound bites in its entirety, three times in a row.

Referring now to FIGS. 3-5, in other words, when the user presses the top play button 46A, the native language audio segment 115 (for example, in English) of the first sound bite 110 in the group 112 plays once and then the target language audio segment 120 (for example, in French) plays three times in a row, allowing the user to hear it and repeat it three times. After the user hears the (e.g., French) target language audio segment 120 each time, there is a pause afterward while the silent audio segment 130 plays, to allow the user to repeat and practice pronouncing the (e.g., French) target language audio segment 120. After the first target language sound bite 110 of the group 112 plays three times, the device 10 advances to the second sound bite 110 within the group 112. Subsequent use of the top play button 46A of this embodiment automatically rewinds or otherwise starts over at the first sound bite 110 within the group 112 of five sound bites 110. So if the user is playing Sound Bite:1-Sound Bite:5 of the group 112, the device will return to Sound Bite:1 and start playing it when the user presses the top play button 46A. This top play button 46A is particularly useful when the user is initially learning the sound bites 110 and/or the target language and allows the user to remain in control of the user-defined session content.

Referring now to FIGS. 3 and 5, when the user presses the middle play button 46B, the device 10 plays the (e.g., French) target language audio segment 120 three times, without playing the (e.g., English) native language audio segment 115. This middle play button 46B is used when the user has heard the sound bite 110 enough so that the user generally knows what it means in English or another native language, and just needs to keep hearing it and repeating it in (e.g., French) the target language. Subsequent use of the middle play button 46B also automatically rewinds or otherwise starts over at the first sound bite 110 after playing all five sound bites 110 of the group 112, so the user can easily keep practicing the same group 112 of sound bites, such that the user remains in control of the user-defined session content.

Referring still to FIGS. 3 and 5, the bottom play button 46C plays each (e.g., French) foreign language audio segment 120 of each of the sound bites 110 in the group 112 once. Such bottom play button 46C is particularly useful for a final listen and practice of a group 112 of sound bites 110 before the user moves on to the next group 112 of sound bites 110. This play button does not rewind or otherwise start over to the first sound bite 110 played and, instead, when the user presses any play button 46A, 46B, 46C, after using the bottom play button 46C, the device 10 starts with the next consecutive group 112 of sound bites 110, in this example, the next group 112 including Sound Bite:6-Sound Bite:10, whereby the user is able to dynamically redefine the user-defined session content, as desired, by advancing through the audio content 100 a group 112 at a time.

Referring again to FIGS. 3-5, the user can further initially establish or modify the user-defined session content by way of the selecting system 50, either before the learning session has started or while the learning session is underway. Sound bite selector 55 can be used to initially define or dynamically redefine which particular sound bites 110 are in the group 112. For example, a user can select a single sound bite 110, whereby the group 112 is the selected sound bite 110, alone, which can be played using play button 46A to play both the native language audio segment 115 and target language audio segment 120 three times in a row. Then the user can replay the same sound bite 110 three more times by pressing the play button 46A again, can advance to the next sound bite 110 within the audio content 100, which may be one number larger, or choose other content to practice.

Still referring to FIGS. 3-5, otherwise, the sound bite selector 55 can be used to initially define a group 112 of more than one sound bites 110 for a particular session content, for repeated practice. For example, if after learning the first fifty sound bites 110 a user decides that he or she is having particular trouble with Sound Bite:7, Sound Bite: 12, Sound Bite: 20, Sound Bite:34, Sound Bite:40, Sound Bite:41, and Sound Bite:42, then the user selects these particular sound bites by entering the corresponding numbers into the keypad of the sound bite selector 55 and defines them collectively as a group 112. The device 110 then plays this user-defined group 112, for example, according to the procedures and play/repeat characteristics described above with respect to the functions of play buttons 46A, 46B, 46C, only with this particular user-defined group 112 instead of the numerical first five sound bites 110 of the audio content 100 as was described above. The user-defined group 112 may be dynamically redefined using the sound bite selector 55 during the learning session and may be saved onto the memory 20 of the device 10 for later practice of the same user-defined group 112, as desired.

To yet further control and/or customize the session content, the user manipulates the speed mode selector 60 to control whether the slow speed version 120A and/or natural speed version 120B of the target language audio segment 120 is played while playing the sound bite 110. Selecting a slow-only mode plays only the slow speed version 120A of each sound bite 110 as it is being played. Selecting a natural-only mode plays only the natural speed version 120B of each sound bite 110 as it is being played. Selecting a slow and natural mode plays both the slow speed version 120A and the natural speed version 120B of each sound bite 110 as it is being played. This allows the user to control how the target language audio segment 120 is presented while using the above described play/repeat characteristics associated with the corresponding functions of play buttons 46A, 46B, 46C.

Still referring to FIGS. 3-5, as another example of how the user controls and/or customizes the session content, the user manipulates the progression mode selector 65 to determine or influence how the device 10 might advance through the audio content 100 during the learning session. For example, the progression mode selector 65 allows the user to select whether, (i) the device 10 plays one sound bite 110 and stops, (ii) plays more than one, such as five, sound bites 110 in sequence and then stops, (iii) plays all sound bites 110 in sequence continuously until the end, and/or (iv) other progression sequences, such as, for example, defining a particular number of sound bites 110 played in a row before stopping can be selected by the user.

In some embodiments, the progression mode selector 65 is used to implement a play-and-repeat sequence or return mode in which the device 10 plays a user-selected sound bite 110 or bites 110 of a group 112 and then rewinds or otherwise starts over at the beginning of the first sound bite 110 played for easy repeat practice by, for example, subsequently pressing the progression mode selector 65 or one of the play buttons 46A, 46B, 46C. The progression mode selector 65, in some embodiments, is used to implement a progress sequence or mode in which the device 10 plays a user-selected sound bite 110 or bites 110 of a group 112 and then the device 10 advances or progresses to the next sound bite 110 or bites 110 of a group 112. The return and progress sequences or modes can be simultaneously made available to allow the user to decide whether to repeat the sound bite 110 or bites 110 of a group or advance to the next sound bite 110 or bites 110 of a group 112. This can be done by, for example, assigning the return mode to top play button 46A and progress mode to middle play button 46B so that the user pushes the particular play button 46A or 46B that corresponds to the desired task of returning or progressing. This allows the user to easily immediately switch between (i) repeating or returning to a particular sound bite 110 or bites 110 of a group 112 bites for repeated practice, or (ii) advancing or progressing to the next sound bite 110 or group 112 of sound bites 110, so as to dynamically redefine the user-defined session content.

Referring still to FIGS. 3-5, repeat mode selector 70 allows the user to control and/or customize the session content, namely, by allowing the user to choose how many times in a row each sound bite 110 is played before stopping or advancing to the next sound bite 110. Repeat mode selector 70 can be used to implement a repeat-once mode in which the device 10 plays a sound bite 110 or bites 110 of a group 112 and then repeats the sound bite 110 or bites 110 of a group 112 a single time before stopping or advancing to the next sound bite 110 or group 112. A repeat-twice mode can be implemented through the repeat mode selector 70. When the device 10 is operating in the repeat-twice mode, the sound bite 110 or group 112 of sound bites 110 is repeated two times before stopping or advancing to the next sound bite 110 or group 112.

In some embodiments, the repeat mode selector 70 can further implement a repeat-continuously mode in which the device 10 repeatedly plays the sound bite 110 or group 112 of sound bites until the user stops the playing. Optionally, the repeat mode selector 70 allows the user to define the particular number of times that the sound bite 110 or group 112 is repeated, for example, ten times and then later redefine the number of repeated plays of the sound bite 110 or group 112 to be twelve, twenty, or any other number of times that the user may want to repeatedly play and correspondingly dynamically redefine the session content.

Referring still to FIGS. 3-5, preferably, device 10 is configured to initially establish or modify the user-defined session content by using various combinations of the above-discussed implementations of the selecting system 50, either before the learning session has started or while the learning session is underway. In other words, different combinations of the various functions, settings, and/or modes may be set at the same time. As just one example, a user may set the device 10 at (i) both slow and natural speed for the target language audio segment 120, (ii) progressively play five sound bites 110 starting at Sound Bite:6, and (iii) repeat continuously. With the device 10 set up in this way, the device 10 will play Sound Bite:6, Sound Bite:7, Sound Bite:8, Sound Bite 9, and Sound Bite 10 in that order. Within each of the sound bites, the device 10 plays the native language audio segment 115, the target language audio segment slow speed version 120A, the target language audio segment natural speed version 120B, and then the silent audio segment 130 to give the user an opportunity to pronounce the particular word, phrase, or sentence of that sound bite 110 before progressing to the next. After the device 10 has played the entire group 112 and therefore after playing Sound Bite:10, the device 10 automatically rewinds or otherwise starts over at the Sound Bite:6 and this is repeated again and again until the user stops the playing of the sound bites 110. Yet other combinations of the various functions, settings, and/or modes may be set at the same time or individually, based on the particular session content that the user wants to establish or redefine for a given learning session.

Still referring to FIGS. 3-5, in one preferred use of the system, the user will use the selector means to choose 5 consecutive sentences to hear and repeat in a given use session which, for example, are sentences 51-55. The user will choose to play each sentence one time in their native language, followed by 3 times in the target language, and will choose to play the entire group of five sentences sequentially 25 times before stopping. The user will use the device and system this way while getting dressed in the morning, while driving to work, and while making dinner. The next day, the user will review this same group of sentences while getting dressed but will not play the native language sentence, and then advance to sentences 56-60 for practice as was done for sentences 51-55, while driving to work, while driving home, and while making dinner. Using the device in this manner, the user makes no attempt to memorize the target language sentences or translate them directly or word for word. They simply repeat the sounds they hear and have a general idea of the meaning from the native language sentence provided, but do not refer back to this sentence or try to recall it while repeating the sound of the target language sentence. This is reinforced when the sentences are reviewed again without the native language sentences. The user may repeat this process as many times as desired for any of the sentences (sound bites). At no point is there any direct attempt to memorize the sentences or translate them. They are simply heard and repeated to allow the audio imprinting process to occur. The general meaning of the sentences is acquired naturally through the process of repetition in the context of the native language sentence without any direct effort at memorization or translating individual words. The selector means are configured to easily permit the user to set the device to play the chosen sentences in the chosen manner. The system is uniquely designed to enable this process of multiple repetition of sound bites for natural audio imprinting and acquisition of spoken language and meaning without attempts at memorization or analytic effort.

Many changes and modifications may be made to the present invention without departing from the spirit thereof. The scope of some of these changes is discussed above. The scope of others will become apparent from the appended claims.

We claim:

1. A system for learning a target language, comprising:
an electronic device being configured to store audio-based content thereon for teaching a user of the system a target language, the audio-based content including multiple sound bites, wherein each sound bite includes:
(i) a native language audio segment defined by at least one of a word, phrase, or sentence that is audibly rendered in a native language to the user; and
(ii) a target language audio segment that is an audible rendering of the native language audio segment in the target language being practiced by the user; and
a user interface interacting with the electronic device and including a selector that is configured to individually select one of the sound bites or a group of sound bites so as to provide a user-defined session content to be listened to by the user during a use session.

2. The system of claim 1, wherein the electronic device is portable and the sound bite or group of sound bites is user-defined and wherein the sound bite or ground of sound bites is repeated during the use session.

3. The system of claim 2, further comprising a repeat mode selector that influences how many times the sound bite or group of sound bites will be automatically repeated during the use session.

4. The system of claim 3, further comprising an individual repeat selector that, when activated, instructs the device to repeat a sound bite that is currently being audibly rendered or has previously been audibly rendered, one or more times as selected by the user.

5. The system of claim 3, further comprising at least one of (i) a repeat-once setting in which the sound bite or group of sound bites is repeated a single time, and (ii) a repeat-twice setting in which the sound bite or group of sound bites is repeated two times.

6. The system of claim 3, further comprising a means on the user interface to allow the user to determine the number of times a selected sound bite or group of sound bites will be repeatedly played before stopping play, or advancing to the next sound bite or group of sound bites.

7. The system of claim 3, further comprising a means on the user interface to allow the user to select the number of times a given target language sound bite will be repeatedly played before advancing to the next sound bite in a group of sound bites, or stopping play if only one sound bite has been chosen for practice.

8. The system of claim 3, further comprising a repeat-continuously setting in which the sound bite or group of sound bites is repeated continuously until the user commands the device to cease audibly rendering the sound bite or group of sound bites.

9. The system of claim 1, wherein the target language audio segment further comprises (i) a slow speed version thereof, and (ii) a natural speed version thereof, wherein the slow speed version of the target language audio segment is an audio representation of a slower delivery of the word, phrase, or sentence of the sound bite when compared to the natural speed version, and wherein the electronic device further comprises a speed selector that is manipulated to control whether at least one of the slow and natural speed versions of the target language audio segment is audibly rendered during the audible rendering of the sound bite.

10. The system of claim 1, further comprising a speed selector that allows the user to select between more than one delivery speed for the audibly rendered sound bite or group of sound bites, the more than one delivery speed including (i) a slower than natural speaking speed so as to facilitate hearing of the audibly rendered sound bite or group of sound bites, and (ii) a natural speaking rate so as to produce delivery realism in the audibly rendered sound bite or group of sound bites.

11. The system of claim 1, further comprising a progression selector that allows the user to determine how many different sequential or user selected sound bites are i) being audibly rendered in row before stopping play or ii) played continuously.

12. The system of claim 11, wherein the electronic device is portable.

13. The system of claim 1, wherein the sound bites are rendered in a progressive sequence during the learning session.

14. The system of claim 13, wherein at least one of the sound bites is audibly rendered more frequently than another one other of the sound bites during the learning session.

15. The system of claim 13, wherein each of the sound bites is electronically tagged for individual identification and selection by way of the device.

16. The system of claim 1, wherein each of the sound bites has a duration of no more than about 15 seconds.

17. The system of claim 1, wherein the target language audio segment of each of the sound bites has a duration of no more than about 15 seconds.

18. The system of claim 1, wherein multiple sound bites are provided in a single audio file and wherein each of the multiple sound bites is configured to be individually selected by the user for individual audible rendering from within the single audio file.

19. The system of claim 1, the device further comprising at least about 100 sound bites stored thereon.

20. The system of claim 19, the device further comprising at least about 1000 sound bites stored thereon.

21. A method of learning a target language, comprising:
providing an electronic device that is configured to store audio-based content thereon or access audio-based content therethrough for teaching a user of the device a target language;
providing multiple sound bites that are stored on the device or accessible through the device, wherein each sound bite includes:
(i) a native language audio segment defined by at least one of a word, phrase, or sentence that is audibly rendered in a native language to the user; and
(ii) a target language audio segment that is an audible rendering of the native language audio segment in the target language being learned by the user; and
establishing a user-defined session content by having the user select at least one sound bite that will be audibly rendered during a practice session.

22. The method of claim 21, further comprising repeating the at least one sound bite of the user-defined session content during the learning session.

23. The method of claim 21, further comprising redefining the user-defined session content during the learning session by changing which sound bite or sound bites will be audibly rendered during the remainder of the use session, or changing the number or repetitions of each sound bite or group of sound bites, or changing which sound bites are being included in the user-defined session content during the remainder of the learning session, so as to dynamically re-define the user-defined session content.
